(19) United States
(12) Patent Application Publication
(10) Pub. No.: US 2026/0148284 A1
(43) Pub. Date: May 28, 2026

(54) MAPPING MULTIPLE ITEM ORDERS TO A SERVICE ORDER

(71) Applicant: eBay Inc., San Jose, CA (US)

(72) Inventor: Richard CHANDRAGUPTHARAJAH, Fremont, CA (US)

(21) Appl. No.: 18/957,476

(22) Filed: Nov. 22, 2024

(51) Int. Cl. G06Q 30/0601

(52) U.S. Cl. CPC G06Q 30/0635; G06Q 30/0627; G06Q 30/0631; G06Q 30/0641

(57) ABSTRACT

Some aspects relate to technologies for a listing platform that facilitates searching multiple items to perform a service and mapping item orders to a service order. In accordance with some aspects, the listing platform receives input indicative of one or more services and a service provider to provide the service(s). The listing platform queries a services data store to identify items for performing the service(s). The listing platform queries an item listings data store to identify item listings for each item. The listing platform provides a user interface presenting an indication of the items and the item listings for each item. The listing platform receives input indicative of an item listing for each item. The listing platform generates at least one service order for the service(s) and item orders for the selected item listings. The listing platform also maps the item orders to the service order(s).

### BACKGROUND

Listing platforms, such as e-commerce websites, are online platforms that offer items (e.g., products) to users by providing user interfaces to user devices to allow users to find item listings for items to purchase. Such platforms typically offer a vast number of items. While some items are relevant to any given user, the majority is not. As a result, item retrieval for listing platforms is a particular Internet-centric problem that has proven to be difficult to fully address. That is, given a large number of items available on a listing platform, what items should be retrieved and presented to a user and in what order. Given the vast number of items available, listing platforms include item retrieval functionality, such as search and recommendation, to assist users in finding items of interest on the platforms. For instance, listing platforms often provide search capabilities that receive user queries and return search results identifying items relevant to the user queries. Listing platforms also often leverage recommendation systems to recommend items that are likely of interest to users based on a variety of information, such as an item currently being viewed by a user, user attributes, and user behavior on the listing platforms (e.g., previous item views, purchases, etc.).

### SUMMARY

Some aspects of the present technology relate to, among other things, technologies for a listing platform to facilitate searching for multiple items needed to perform a service or set of services and mapping item orders for the items to a service order for the service(s). This enables the listing platform to efficiently search for and select multiple items required for a specific service, such as car maintenance, and map the item orders to a service order. The technology leverages a services data store to identify relevant items and service providers for services. In accordance with some aspects, the listing platform initially employs the services data store to facilitate a user selection of one or more services and a service provider to provide the service(s). The listing platform also queries the services data store to identify items for performing the selected service(s). After identifying items for the service(s), the listing platform queries an item listings data store to identify item listings for each item. The listing platform provides a user interface presenting an indication of the items and the item listings for each item, allowing the user to view each item needed for the service(s) and to select an item listing for each item. Accordingly, the listing platform receives, via the user interface, input indicative of the user selecting an item listing for each item. The listing platform generates at least one service order for the service(s) and item orders for the selected item listings. The listing platform also maps the item orders to the service order(s).

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing an example schema for a services data store in accordance with some implementations of the present disclosure;

FIG. 3 is a block diagram showing an example schema for an orders data store in accordance with some implementations of the present disclosure;

FIGS. 4A-4D are example user interfaces illustrating interaction with the listing platform to select a service, service provider, and item listings for items to provide the service in accordance with some implementations of the present disclosure;

FIG. 5 is a flow diagram showing a method for searching multiple items to perform a service provided by a service provider and mapping item orders for the items to a service order for the service in accordance with some implementations of the present disclosure;

FIG. 6 is a flow diagram showing a method for searching multiple items to perform a service and mapping item orders for the items to a service order for the service in accordance with some implementations of the present disclosure;

FIG. 7 is a flow diagram showing a method for establishing a chat session between a user and an agent to facilitate curating items for a service in accordance with some implementations of the present disclosure; and

FIG. 8 is a block diagram of an exemplary computing environment suitable for use in implementations of the present disclosure.

### DETAILED DESCRIPTION

### Overview

Many listing platforms (e.g., e-commerce websites) offer a large number of item listings. To facilitate item retrieval, listing platforms typically employ computer-based search systems in which end users can submit search queries from user devices over a network (e.g., the Internet) to search servers of the listing platforms. The search servers query data stored in electronic databases to return, over the network to the user devices, search results that identify certain item listings from the databases.

Sophisticated computer-based search technologies are essential for efficiently navigating the vast amount of information available on listing platforms. For instance, search technologies use indexing, complex algorithms, machine learning, and natural language processing with the goal of providing search results that are relevant and accurate. Given the millions or even billions of item listings on listing platforms (e.g., it has been reported that as of 2023, eBay has 1.7 billion item listings) and the vast number of users (e.g., it has been reported that as of 2023, the monthly number of eBay visits reached almost 3 billion), these computer-based search technologies are necessary for providing practical search systems that can efficiently process search queries from users in order to provide relevant search results with sufficiently low latency. In particular, low latency is crucial for search systems, as users expect near-instantaneous search results.

Moreover, each search query involves consumption of computer resources (e.g., bandwidth, memory, CPU usage), as well as puts wear and tear on physical computer components. Given the vast number of item listings available on listing platforms and the high volume of users accessing the listing platforms, the computer resources consumed for search purposes on listing platforms is extensive. If the search system is ineffective in returning relevant search results, users will submit additional search queries until relevant search results are returned. These repetitive search queries can exponentially increase the computer resource consumption of the search systems. Designing search systems to provide relevant items from listing platforms to reduce such repetitive search queries and their corresponding computer resource consumption is a technical problem faced by listing platforms.

In some cases, users are searching for a number of items on a listing platform that are related to a particular service or project. For instance, a user may be performing maintenance on their automobile and need a number of items, such as new tires, engine oil, engine oil filter, etc. The user may also want to identify a service provider to perform the service. Currently, listing platforms do not support identifying service providers for services requiring multiple items and also do not facilitate efficiently identifying multiple items for a given service or set of services. Instead, conventional listing platforms require the user to determine what items are needed and to perform searches on the listing platform for each item separately. Due to a number of limitations (e.g., inaccuracy of keyword queries, compatibility of different items, users are uncertain of what type of items they need, etc.), users often have to submit multiple queries for each item in order to find particular items to purchase. This results in numerous search inputs to the system, thereby placing extensive computer resource consumption on the search system as discussed above.

Accordingly, while current search systems are useful tools for locating item listings on listing platforms, shortcomings in existing search technologies used by listing platforms often result in the consumption of an unnecessary quantity of computing resources (e.g., I/O costs, network packet generation costs, throughput, memory consumption, etc.). As a result of shortcomings in conventional search systems, users often have to submit multiple queries before finding desired item listings as noted above. For example, for each given item associated with a service or set of services, a user issues a first query to a search engine of a listing platform that returns a set of search results. The user may browse the search results and select certain search results to access the corresponding item listings. Selection of search results causes retrieval of the corresponding item listings. Additionally, in some cases, applications are launched in order to render data associated with the item listings. When the search results are insufficient, the user often revises the search query and performs another search. This search revision process could continue for a number of iterations until the user finds a desired item listing for an item. This search process is sequentially performed by the user for each of the items needed for the service.

These repetitive inputs result in increased computing resource consumption for the listing platform, among other things. For instance, repetitive user queries result in packet generation costs that adversely affect computer network communications. Each time a user issues a query, the contents or payload of the query is typically supplemented with header information or other metadata within a packet in TCP/IP and other protocol networks. Accordingly, when this functionality is multiplied by all the inputs needed to obtain the desired data, there are throughput and latency costs by repetitively generating this metadata and sending it over a computer network. In some instances, these repetitive inputs (e.g., repetitive clicks, selections, or queries) increase storage device I/O (e.g., excess physical read/write head movements on non-volatile disk) because each time a user inputs unnecessary information, such as inputting several queries, the computing system often has to reach out to the storage device to perform a read or write operation, which is time consuming, error prone, and can eventually wear on components, such as a read/write head. Further, if users repetitively issue queries, it is expensive because processing queries consumes a lot of computing resources. For example, for some listing platforms, a query execution plan may need to be calculated each time a query is issued, which could require a system to find the least expensive query execution plan to fully execute the query. This decreases throughput and increases network latency, and can waste valuable time.

Aspects of the technology described herein improve the functioning of the computer itself in light of these shortcomings in existing search technologies for listing platforms by providing a solution in which a listing platform is designed to facilitate the efficient search and selection of multiple items required to perform a specific service or set of services, such as car maintenance. The listing platform also maps item orders for items to a corresponding service order for the service(s), providing a streamlined approach.

The listing platform described herein employs a services data store to identify relevant items and service providers for various services. Initially, the listing platform queries the services data store based on user input to enable a user to select one or more services and a service provider. Based on a selected service or set of services, the listing platform queries the services data store to identify the items to perform the selected service(s). After identifying the items, the listing platform queries an item listings data store to find item listings for each identified item. The listing platform then provides a user interface presenting an indication of each these items and their corresponding item listings, allowing the user to view and select the appropriate item listings for each item. Upon receiving user input selecting an item listing for each item, the listing platform generates at least one service order for the selected service(s) and item orders for the selected item listings. The listing platform also maps the item orders to the corresponding service order, ensuring that all item orders are linked to the service order. This mapping facilitates, among other things, the coordination and delivery of items to the service provider, ensuring that all items required for the service are available when needed.

Some further aspects facilitate identification of item listings for a service or set of services that does not involve a service provider. For instance, one aspect is directed to facilitate item listing retrieval for items for a service (or project) that the user intends to perform themselves (e.g., do-it-yourself project). The listing platform receives a user selection of a service or set of service(s). However, no service provider is selected. Similar to the above approach, the services data store is queried to identify items for the service(s), and the item listings data store is queried to retrieve item listings for each item. The listing platform provides a user interface with the items and corresponding items listings, and receives, via the user interface, a selection of an item listing for each item. The listing platform generates an item order for each item and can associate the item orders with one another (e.g., by associating the item orders with an overall service order).

In further aspects, the listing platform facilitates agent-assisted curation of items for services. Given a selected service or set of services, the listing platform queries the services data store to identify agents for the service(s). Each agent is a human that can be considered an “expert” for certain services or service categories. Given a user selection of an agent for a selected service, the listing platform establishes a chat session between a user device of the user and a user device of the selected agent. During the chat session, the agent assists the user in selecting item listings, and the listing platform generates item orders for each selected item listing and can associate the item orders with one another (e.g., by associating the item orders with an overall service order).

Aspects of the technology described herein provide a number of improvements over existing item retrieval technologies for listing platforms. For instance, compared to existing listing platforms, the technology provides a non-conventional and non-generic configuration that provides for significantly improved efficiency in searching for items needed to perform services. By integrating the search and selection process for both services and item listings for items into a single platform, considerable time and effort is saved. The listing platform's ability to map item orders to service orders ensures that all necessary items are correctly associated with the service, reducing the risk of errors and omissions. Additionally, the use of a services data store and an item listings data store allows for a more organized and systematic approach to identifying and selecting item listings for items needed to perform services. This structured approach enhances the accuracy and relevance of search results, providing users with more precise options tailored to their specific service needs. For instance, by having pre-defined items for each service, relevant item listings are retrieved for each item required for a given service.

The technology described herein also reduces the computational load on listing platforms, relative to existing item retrieval technologies, by minimizing repetitive search queries, search result selections, and rendering of item listings. By efficiently identifying and presenting relevant items for services and corresponding item listings for each item, the listing platform described herein decreases the need for processing multiple searches from users, thereby reducing the consumption of computing resources such as bandwidth, memory, and CPU usage. This efficiency improves the overall performance and scalability of the listing platform. For instance, a user query (e.g., an HTTP request) would traverse a computer network fewer times relative to existing technologies. Specifically, the contents or payload of the user query is supplemented with header information or other metadata within a packet in TCP/IP and other protocol networks for fewer queries. Such packets for user queries are sent over the network fewer times. Thus, there is no repetitive generation of metadata and continuous sending of packets over a computer network.

In like manner, aspects of the technology described herein improve storage device or disk I/O and query execution functionality, as they only need to go out to disk a single time (or fewer times relative to existing search technologies). As described above, the inadequacy of existing search technologies on listing platforms results in repetitive user queries, search result selections, and item listing renderings. This causes multiple traversals to disk. In contrast, aspects described herein reduce storage device I/O because reduced inputs are received and so the computing system does not have to reach out to the storage device as often to perform a read or write operation. Accordingly, there is not as much wear on hardware components, such as a read/write head, because disk I/O is substantially reduced.

### Example System for Mapping Multiple Item Orders to Service Order

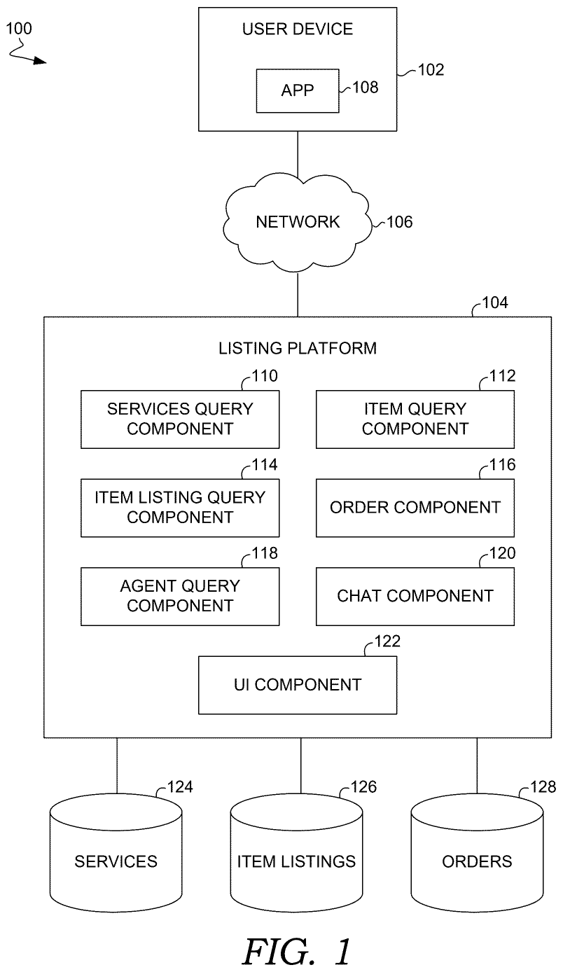

With reference now to the drawings, FIG. 1 is a block diagram illustrating an exemplary system 100 for a listing platform that facilitates searching multiple items to perform a service and mapping item orders for the items to a service order for the service in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

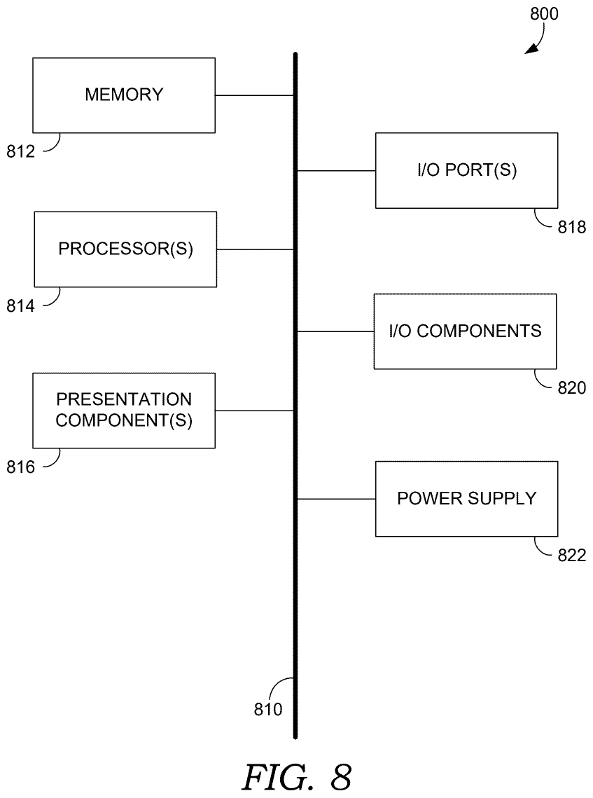

The system 100 is an example of a suitable architecture for implementing certain aspects of the present disclosure. Among other components not shown, the system 100 includes a user device 102 and a listing platform 104. Each of the user device 102 and the listing platform 104 shown in FIG. 1 can comprise one or more computer devices, such as the computing device 800 of FIG. 8, discussed below. As shown in FIG. 1, the user device 102 and the listing platform 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the listing platform 104 could be provided by multiple server devices collectively providing the functionality of the listing platform 104 as described herein. Additionally, other components not shown may also be included within the network environment.

The user device 102 can be a client device on the client-side of operating environment 100, while the listing platform 104 can be on the server-side of operating environment 100. The listing platform 104 can comprise server-side software designed to work in conjunction with client-side software on the user device 102 so as to implement any combination of the features and functionalities discussed in the present disclosure. For instance, the user device 102 can include an application 108 for interacting with the listing platform 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the listing platform 104 remain as separate entities. While the operating environment 100 illustrates a configuration in a networked environment with a separate user device and content server, it should be understood that other configurations can be employed in which aspects of the various components are combined. For instance, in some aspects, aspects of the listing platform 104 can be implemented at least in part by the user device 102 and vice versa.

The user device 102 may comprise any type of computing device capable of use by a user. For example, in one aspect, a user device may be the type of computing device 800 described in relation to FIG. 8 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the listing platform 104 via the user device 102.

As shown in FIG. 1, the listing platform 104 includes a services query component 110, an item query component 112, an item listing query component 114, an order component 116, an agent query component 118, a chat component 120, and a user interface component 122. The components of the listing platform 104 may be in addition to other components that provide further additional functions beyond the features described herein. The listing platform 104 can be implemented using one or more server devices, one or more platforms with corresponding application programming interfaces, cloud infrastructure, and the like. While the listing platform 104 is shown separate from the listing platform 104 and the user device 102 in the configuration of FIG. 1, it should be understood that in other configurations, some of the functions of the listing platform 104 can be provided on the listing platform 104 and/or the user device 102. Additionally, while the components are shown as part of the listing platform 104, in other configurations, one or more of the components can be provided by the listing platform 104 or another location not shown in FIG. 1. The components can be provided by a single entity or multiple entities.

In some aspects, the functions performed by components of the listing platform 104 are associated with one or more applications, services, or routines. In particular, such applications, services, or routines may operate on one or more user devices, servers, may be distributed across one or more user devices and servers, or be implemented in the cloud. Moreover, in some aspects, these components of the listing platform 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The listing platform 104 generally provides, to user devices such as the user device 102, item listings describing items available for purchase using the listing platform 104. For instance, the listing platform 104 could comprise an e-commerce platform, in which listed products are available for purchase by users of user devices upon navigation to the listing platform 104. The functionality of the listing platform 104 includes provision of interfaces (e.g., via the user interface component 122) enabling surfacing of item listings for items to users of the listing platform 104. Item listings for items available for sale via the listing platform 104 are stored by the item listings data store 126. Each item listing can include a description relating to an item comprising one or more of a price in a currency, reviews, images of the item, shipment options, a rating, a condition of the item, a size of the item, a color of the item, etc. In aspects, each item listing is associated with one or more categories including meta-categories and leaf categories. For example, the meta-categories are each divisible into subcategories (or branch categories), whereas leaf categories are not divisible.

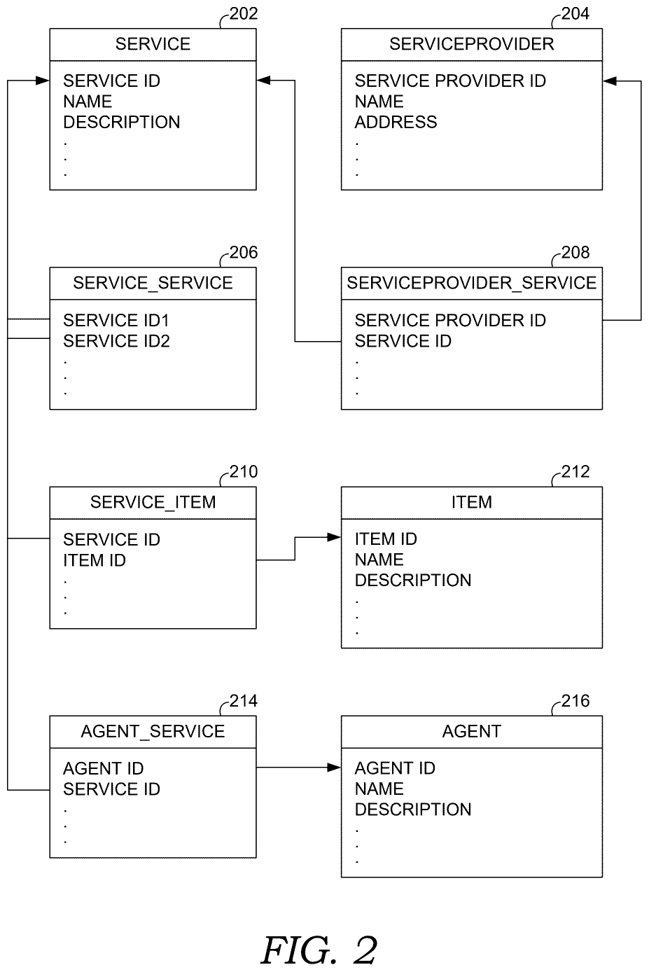

In addition to information regarding item listings stored in the item listings data store 126, the listing platform 104 stores information regarding services offered by service providers in a services data store 124. FIG. 2 provides an example schema 200 for a relational database structured to efficiently manage and retrieve services-related data that could be used to provide the services data store 124. However, it should be understood that the schema 200 shown in FIG. 2 is provided by way of example only and not limitation and the services data store 124 in FIG. 1 can take various different forms, such as a NoSQL database or a graph database.

The schema 200 shown in FIG. 2 includes a Service table 202, a ServiceProvider table 204, an Item table 212, and an Agent table 216. The Service table 202 provides information regarding each service, such as a service ID, service name, and service description. The ServiceProvider table 204 provides information regarding each service provider, such as a service provider ID, a service provider name, and a service provider address. The Item table 212 provides information regarding each item that can be used to fulfill services, such as an item ID, item name, and item description. The Agent table 216 provides information regarding each agent that can assist users in identifying items for services, such as an agent ID, an agent name, and an agent description.

To handle complex many-to-many relationships between these entities, the schema 200 can employ junction tables. First, a Service_Service table 206 identifies related services (service ID and service ID 2). In some instances, a primary service can comprise multiple secondary services, and the Service_Service table 206 can be used to link the secondary services to the primary service. For example, maintenance of an automobile at a certain mileage (e.g., 60k mile service) could comprise multiple secondary services (e.g., replace engine oil and oil filter, rotates tires, etc.). A ServiceProvider_Service table 208 specifies which services (service ID) are offered by which service providers (service provider ID). A Service_Item 210 table details the items (item ID) required to perform specific services (service ID). An Agent_Service table 214 indicates the services (service ID) that agents (agent ID) can assist with. This relational structure ensures that the database can efficiently manage interconnected services-related data, providing a robust framework for querying and maintaining relationships between different services-related entities, including services, service providers, items, and agents.

With reference again to FIG. 1, the listing platform 104 includes a services query component 110 that facilitates searching the services data store 124 for services and service providers. Given an input, the services query component 110 searches the services data store 124 for relevant data. In some instances, the services query component 110 is used to identify services for user selection. For instance, the services query component 110 supports keyword searching for services. Given a keyword search query (e.g., entered by a user via a user device), the services query component 110 identifies relevant services from the services data store 124. The services query component 110 can also enumerate secondary services associated with a given primary service in the services data store 124. In further aspects, given a particular service provider, the services query component 110 enumerates services the service provider can provide.

In some instances, the services query component 110 is used to identify service providers for user selection. For instance, the services query component 110 supports keyword searching for service providers. Given a keyword search query (e.g., entered by a user via a user device), the services query component 110 identifies relevant service providers from the services data store 124. The services query component 110 further supports identifying service providers that can provide one or more selected services. For instance, in response to a user selecting one or more services, the services query component 110 queries the services data store 124 to identify services providers that provide each selected service. In further aspects, when searching for service providers, the services query component can take into account other factors, such as location of the service providers.

The item query component 112 facilitates searching the services data store 124 to identify items for selected services. Given a selected service, the item query component 112 identifies, from the services data store 124, each item needed to perform the selected service. In some cases, a service requires no items; while in other cases, a service requires a single item or multiple items.

While item listings in the item listings data store 126 correspond to specific items for sale at certain prices from certain sellers, the items in the services data store 124 correspond to generic items for services. For instance, a replace engine oil service could be associated with the item “SAE 0W-20 engine oil” in the services data store 124. Accordingly, items identified from the services data store 124 are used to identify item listings for those items. In particular, the item listing query component 114 facilitates searching the item listings data store 126 to identify item listings for items needed to perform selected services.

Given a particular item for a service, the item listing query component 114 generates a query for the item and searches the item listings data store 126 using the query. For instance, the entry for each item in the services data store 124 can include item data that comprises text describing the item, such as a title, a description, and a category. The item listing query component 114 can leverage the item data for an item to provide a query to identify item listings for the item. In some aspects, a pre-defined query is stored as part of the item data in the services data store 124, and the item listing query component 114 retrieves the query and uses the retrieved query to search the item listings data store 126.

The item listing query component 114 can leverage additional data when performing searches for item listings. For instance, in instances in which the item is a part of a primary item (e.g., a part of an automobile) or otherwise needs to be compatible with another item, the item listing query component 114 leverages compatibility data (e.g., fitment data) indicative of which items are compatible with certain items when returning search results. For example, suppose the service is replacing the engine air filter for a particular automobile. In that case, the item listing query component 114 can leverage fitment data to search for engine air filters that are compatible with that particular automobile. In some aspects, the item listing query component 114 includes compatibility data as part querying the item listings data store 126. For example, the compatibility data could identify a fitment or the primary item to which the item needs to be compatible with (e.g., an automobile year, make, and model).

In some aspects, when performing searches for item listings, the item listing query component 114 takes into account item restrictions specified by service providers, which could be stored in the services data store 124 with each service provider. As used herein, an item restriction refers to the limitations or rules imposed by service providers on the types/sources of items they can use while performing their services. These restrictions can be based on factors such as manufacturer specifications, quality standards, compatibility, regulatory compliance, and cost considerations. For example, a cleaning service might only use eco-friendly products from approved brands, or a tech repair service might only use original parts from the device manufacturer. Accordingly, when searching for item listings for items for a selected service and a selected service provider, the item listing query component 114 can enforce any item restrictions specified by the selected service provider. For instance, in the example of a tech repair service only using original parts from the device manufacturer, the item listing query component 114 can filter search results for items to only include item listings for parts from the device manufacturer.

In response to user selections of services, service providers, and/or item listings, the order component 116 generates service orders and item orders that are stored in an orders data store 128. In some instances, the item listings selected for a given service can be provided by different sellers, and a separate item order is generated for each item listing. In some aspects, the order component 116 maps each item order for a given service to the service order for that given service. Among other things, this can facilitate shipping each item to an address of the service provider. For instance, by mapping each item order to the service order, the address of the service provider can be used as the shipping address for each item order.

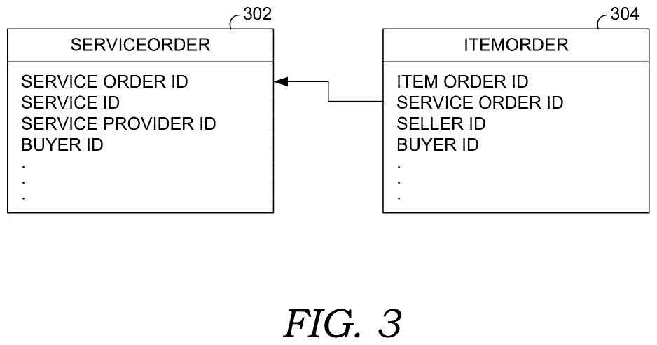

FIG. 3 provides an example of a schema 300 for a relational database structured to efficiently manage and retrieve orders-related data that could be used to provide the orders data store 128. However, it should be understood that the schema 300 shown in FIG. 3 is provided by way of example only and not limitation and the orders data store 128 in FIG. 1 can take various different forms, such as a NoSQL database or a graph database.

The schema 300 shown in FIG. 3 includes a ServiceOrder table 302, and an ItemOrder table 304. The ServiceOrder table 302 provides information regarding each service order, such as a service order ID, a service ID (identifying the service for the service order), a service provider ID (identifying the service provider providing the service), a buyer ID (identifying the user who is ordering the service), and a service cost. The ItemOrder table 304 provides information regarding each item order, such as an item order ID, an item listing ID (identifying the item listing for the item being ordered), a service order ID (identifying the service with which the item order is associated), a seller ID (identifying a seller of the item listing), a buyer ID (identifying the user who is ordering the item from the item listing), and an item price. In the present example schema 300, when multiple item orders are associated with a service order, each item order includes an indication of the service order ID to associate the item orders with the service order. While FIG. 3 illustrates an example in which mapping each item order to the service order is done by associating the service ID with each item order, other approaches may be used, such as establishing a general order (e.g., a bundle order) identified by an order ID that includes the service order and the item orders, and associating the order ID with the service order and the item orders.

Some aspects of the technology described herein support identifying items for selected services that do not involve service providers, such as DIY (do-it-yourself) projects. In such instances, users can select services without selecting service providers. When a user selects a service without a service provider, items are identified for the service by the item query component 112, and item listings are returned for each item by the item listing query component 114. The user selects certain item listings, and item orders are generated and added to the orders data store 128. In some aspects, the item orders can be mapped to one another. For instance, a service order identified by a service order ID could be established that includes the item orders, and the service order ID could be associated with the item orders. In this case, the service order does not include a service provider ID since no service provider is involved. The service order could be considered a general order (e.g., a bundle order) to associate the item orders.

Some further aspects of the technology described herein connect users with agents, who are humans that may be considered “experts” for certain service areas and facilitate curating items for services. The agent query component 118 facilitates searching the services data store 124 to identify agents to assist users in selecting items for services. For instance, in response to a user selecting one or more services, the agent query component 118 queries the services data store 124 to identify agents that can assist with the selected service(s).

When a user selects a given agent to assist with a selected service, the chat component 120 facilitates a chat session between the user and the agent through various methods, each leveraging different technologies. For instance, the chat component 120 can provide text-based chat utilizing web-based chat interfaces or messaging apps. Audio chat can be facilitated through VoIP (Voice over Internet Protocol) services. Video chat leverages video conferencing software, enabling face-to-face interaction. The chat component 120 can also support screen sharing, allowing the agent to view and interact with the user's screen in real-time. This allows the user and the agent to collaborate when selecting item listings for items.

When the user and agent select certain item listings, item orders are generated and added to the orders data store 128. In some aspects, the item orders can be mapped to one another. For instance, a service order identified by a service order ID could be established that includes the item orders, and the service order ID could be associated with the item orders. In this case, the service order does not include a service provider ID since no service provider is involved. The service order could be considered a general order (e.g., a bundle order) to associate the item orders.

The user interface component 122 of the listing platform 104 provides user interfaces to user devices, such as the user device 102, for interacting with the listing platform 104. In some instances, the user interfaces can be presented on the user device 102 via the application 108, which can be a web browser or a dedicated application for interacting with the listing platform 104. For instance, the user interface component 122 can provide user interfaces for, among other things, searching for and selecting services, service providers, agents, and item listings for purchasing items for selected services.

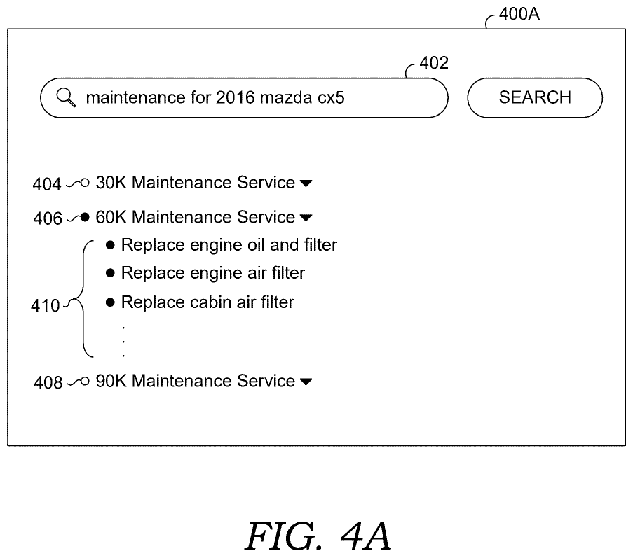

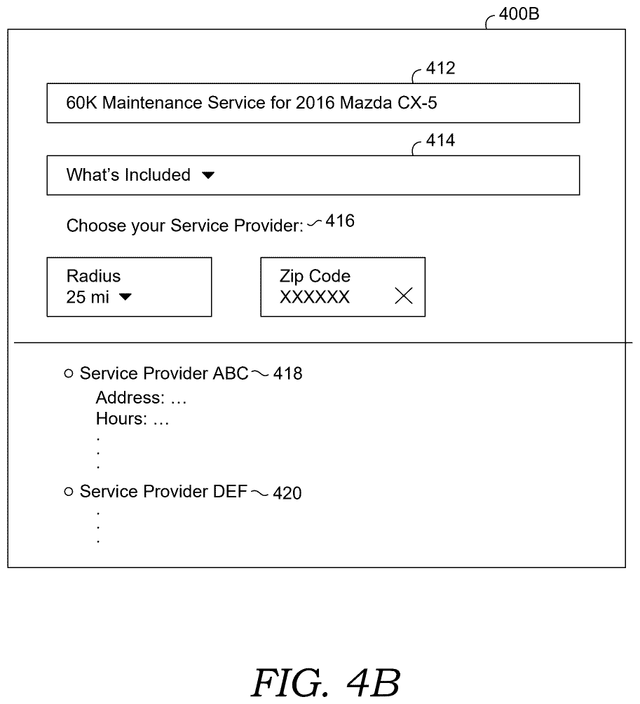

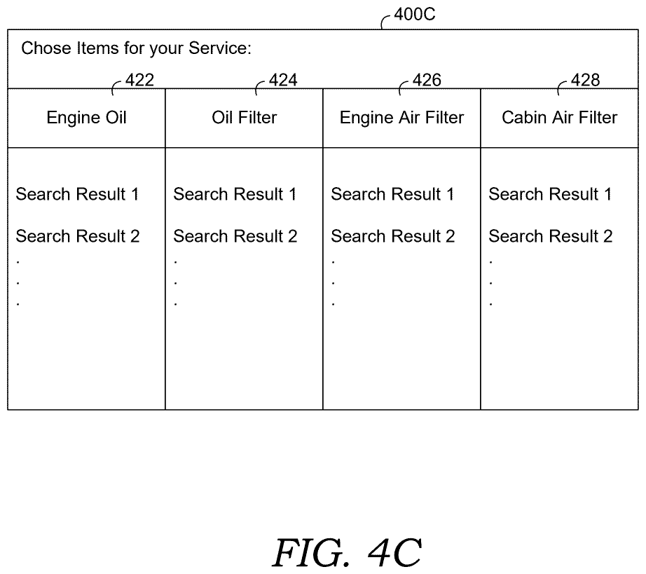

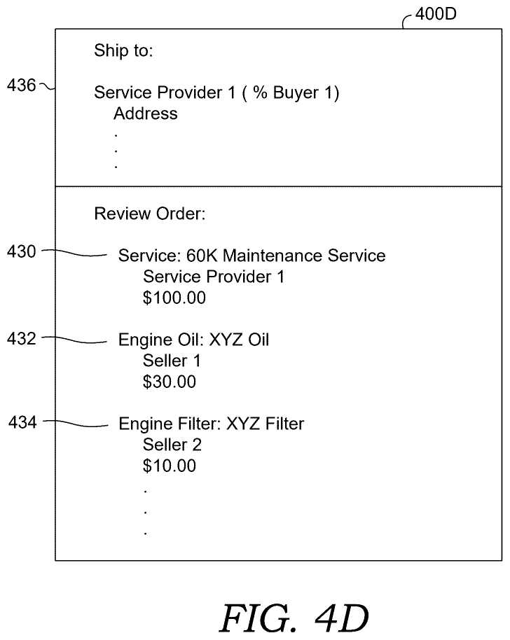

FIGS. 4A-4D provide example user interfaces illustrating interaction with the listing platform 104. Initially, FIG. 4A provides a user interface 400A that illustrates searching for services. The user interface 400A includes a search box 402 in which a user has entered a search query “maintenance for 2016 mazda cx 5.” Based on this search query, a search is performed on the services data store 124 to identify services. Accordingly, the user interface 400A presents a number of services as search results, including a “30k Maintenance Service” 404, a “60k Maintenance Service” 406, and a “90k Maintenance Service” 408. Each of these services 404, 406, 408 in this example is a primary service that includes secondary services that can be viewed by selecting an expansion icon provided with each search result. In the example of FIG. 4A, the user has selected to expand the “60k Maintenance Service” 406, providing the secondary services 410, including: “replace engine oil & filter,” “replace engine air filter,” and “replace cabin air filter.”

In response to the user selecting the “60k Maintenance Service” 406 (including all of its secondary services), a search is performed on the services data store 124 to identify service providers for the selected service, and the user interface 400B of FIG. 4B is presented. The user interface 400B provides an indication of the selected service 412 and an expandable option 414 to view what's included in the selected service (e.g., replace engine oil & filter, etc.). The user interface 400B also provides user interface elements 416 that allow the user to specify a geolocation for the search provider. In the present example, the geolocation is a 25-mile radius around a specified zip code. Other ways for identifying a geolocation could be employed. Based on the selected service and the geolocation, a search is performed on the services data store 124 to identify service providers within the geolocation that can provide the selected service. As shown in FIG. 4B, the search results provide a list of service providers returned from the search, including “Service Provider ABC” 418 and “Service Provider DEF” 420. Information, such as location and hours, can be provided for each service provider. A user can review the various service providers and select a particular service provider to perform the service.

FIG. 4C provides a user interface 400C presenting item listings for each item needed for the selected service. Given the selected service, the services data store 124 is searched to identify items needed for the service. This may include identifying secondary services and items for those secondary services. For each item, a search is performed on the item listings data store 126 to identify item listing search results. This can include applying applicable item restrictions, if any, specified by the selected service provider. The user interface 400C presents each item and its associated item listing search results, including: an “engine oil” item 422 and associated item listing search results, an “oil filter” item 424 and associated item listing search results, an “engine air filter” item 426 and associated item listing search results, and a “cabin air filter” item 428 and associated item listing search results. Using the user interface 400C, the user selects an item listing for each item. While FIG. 4C provides an example in which all items and their associated item listings are provided on a single user interface, in other aspects, the items and their associated item listings can be provided on any number of user interfaces. For instance, the system could sequentially provide separate user interfaces for each item, allowing the user to select item listings for each item from each user interface.

FIG. 4D presents a user interface 400D showing an order for the selected service and selected item listings. The order includes an indication of a service order 430 for the selected service provided by the selected service provider. The order also includes an indication of each item order, including item orders 432 and 434. Information can be provided with the service order 430, such as an indication of the service, the service provider, and the service cost. Information can also be provided with each item order, such as an indication of the item, the seller, and the item cost. Each service order and item order can be added to the orders data store 128, with the item orders associated with the service order. Additionally, the address of the service provider is shown as the shipping address 436 for the order. As such, all items will be shipped to the service provider by each seller.

### Example Methods for Mapping Multiple Item Orders to Service Order

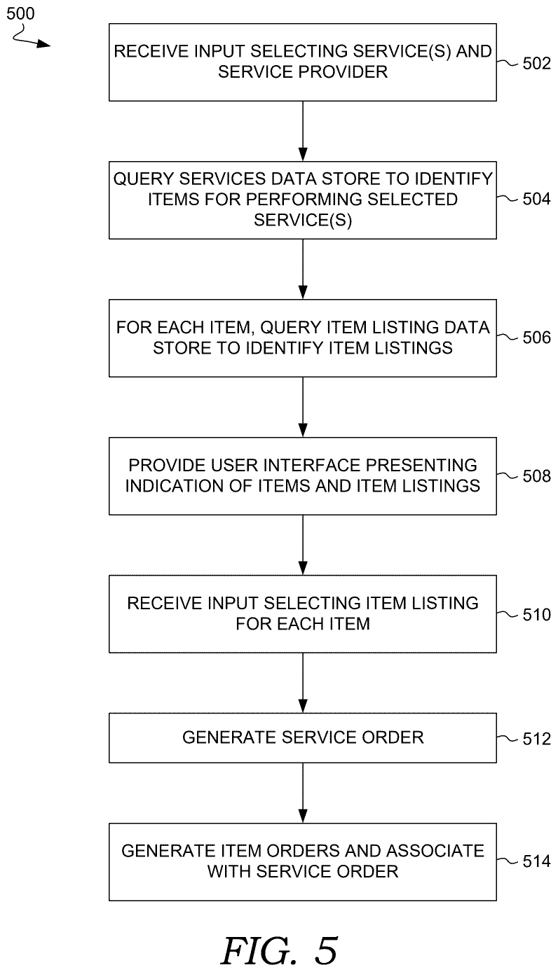

With reference now to FIG. 5, a flow diagram is provided that illustrates a method 500 for searching multiple items to perform a service provided by a service provider and mapping item orders for the items to a service order for the service. The method 500 can be performed, for instance, by the listing platform 104 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, a listing platform receives input selecting one or more services and a service provider to provide the service(s). The selection of the service(s) and the service provider can be performed in a number of different ways. For instance, in some instances, in response to a user first selecting a service, the system provides an indication of a number of service providers for the selected service, from which the user selects a particular service provider to provide the service. In other instances, in response to the user first selecting a service provider, the system provides an indication of number of services offered by the service provider, from which the user selects a particular service. In further aspects, a user can select multiple services to be provided by a given service provider. For instance, in response to a user selecting multiple services (e.g., via searching for each of the services), the system provides an indication of a number of service providers that can provide all those services, from which the user selects a particular service provider. As another example, in response to a user first selecting a service provider, the system provides an indication of services offered by the service provider, and the user selects multiple services. In still further aspects, in response to a user selecting a primary service, the system could automatically select all secondary services for the primary service or the system could provide an indication of secondary services for the primary service from which the user can select some or all of those secondary services. In each of these cases, the system leverages a services data store (e.g., the services data store 124 of FIG. 1) to perform the searches to identify relevant services and service providers for selection.

Based on the selected service(s), the system queries the services data store to identify a number of items for performing the selected service(s), as shown at block 504. When multiple services are selected (including some instances in which a primary service is selected that includes multiple secondary services), the system queries the services data store for each service to identify the items.

As shown at block 506, for each item identified at block 504, the system queries an item listings data store (e.g., the item listings data store 126 of FIG. 1) to identify one or more item listings for each item. In instances in which the selected service provider has item restrictions applicable to any of those items, the item restrictions can be used, for instance, to filter item listings returned for the items.

The system provides, to a user device, a user interface presenting an indication of the items for the service(s) and the one or more item listings for each item, as shown at block 508. This user interface allows the user to view items for the selected service(s) and to select a particular item listing from the available item listings for each item. Accordingly, as shown at block 510, the system receives, via the user interface, input indicative of a selected item listing for each item.

As shown at block 512, the system generates a service order for the selected service(s) by the service provider. The system also generates item orders for the selected item listings and associates the item orders with the service order, as shown at block 514. This ensures that all item orders are associated with the corresponding service order, facilitating the coordination and delivery of the service and the items. In some aspects, this can also include automatically providing the mailing address of the service provider as the shipping address for each item order.

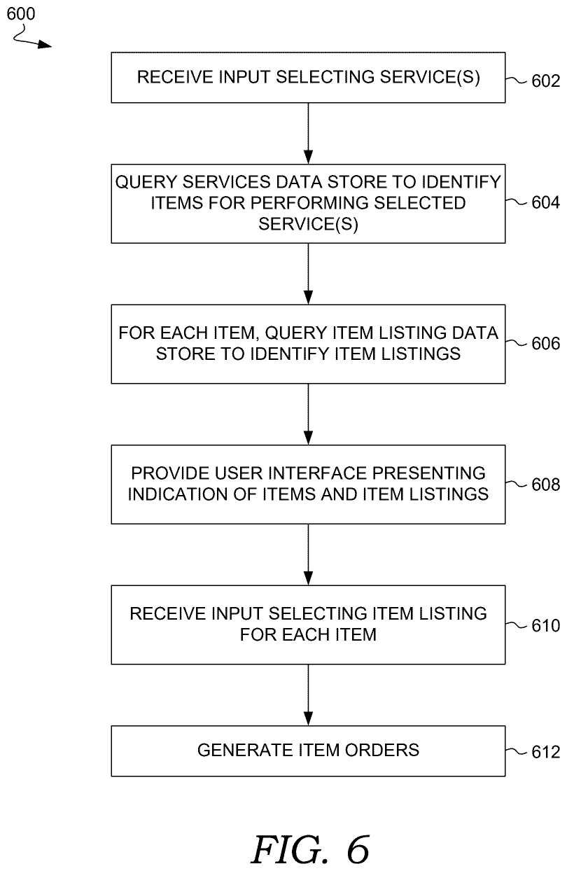

Turning next to FIG. 6, a flow diagram is provided that illustrates a method 600 for searching multiple items to perform a service and mapping item orders for the items to a service order for the service. The method 600 can be performed, for instance, by the listing platform of FIG. 1. As shown at block 602, a listing platform receives input selecting one or more services. The selection of the service(s) can be performed in a number of different ways. For instance, in some cases, a user can select a single service. In other instances, a user can select multiple services (e.g., by searching for each service). In further aspects, in response to a user selecting a primary service, the system could automatically select all secondary services for the primary service or the system could provide an indication of secondary services for the primary service from which the user can select some or all of those secondary services. In each of these cases, the system leverages a services data store (e.g., the services data store 124 of FIG. 1) to perform the searches to identify relevant services for selection.

Based on the selected service(s), the system queries the services data store to identify a number of items for performing the selected service(s), as shown at block 604. When multiple services are selected (including some instances in which a primary service is selected that includes multiple secondary services), the system queries the services data store for each service to identify the items.

As shown at block 606, for each item identified at block 604, the system queries an item listings data store (e.g., the item listings data store 126 of FIG. 1) to identify one or more item listings for each item. The system provides, to a user device, a user interface presenting an indication of the items and the one or more item listings for each item, as shown at block 608. This user interface allows the user to view items for the selected service(s) and to select a particular item listing from the available item listings for each item. Accordingly, as shown at block 610, the system receives, via the user interface, input indicative of a selected item listing for each item. In response, the system generates item orders for the selected item listings, as shown at block 612. In some aspects, the item orders can be associated with one another (e.g., as a bundle order). For instance, a service order identified by a service order ID (with no service provider identified) could be established that includes the item orders, and the service order ID could be associated with the item orders.

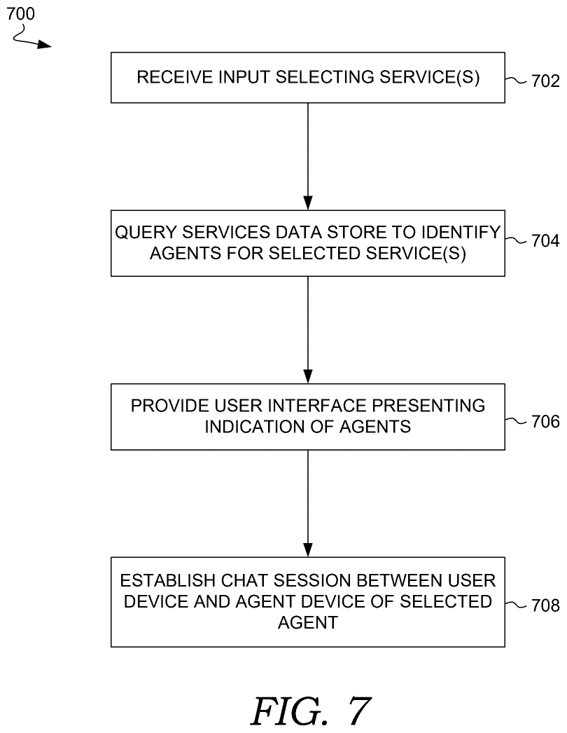

With reference now to FIG. 7, a flow diagram is provided that illustrates a method 700 for establishing a chat session between a user and an agent to facilitate curating items for a service. The method 700 can be performed, for instance, by the listing platform 104 of FIG. 1. As shown at block 702, a listing platform receives input selecting one or more services. The selection of the service(s) can be performed in a number of different ways. For instance, in some cases, a user can select a single service. In other instances, a user can select multiple services (e.g., by searching for each service). In further aspects, in response to a user selecting a primary service, the system could automatically select all secondary services for the primary service or the system could provide an indication of secondary services for the primary service from which the user can select some or all of those secondary services. In each of these cases, the system leverages a services data store (e.g., the services data store 124 of FIG. 1) to perform the searches to identify relevant services for selection.

Based on the selected service(s), the system queries the services data store to identify agents for the service(s), as shown at block 704. The system provides, to a user device, a user interface presenting an indication of the agents, as shown at block 706. In response to a user selection of an agent, a chat session between the agent and the user is established, as shown at block 708.

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving, at a listing platform, input indicative of one or more services and a service provider to provide the one or more services;
querying a services data store of the listing platform based on the one or more services to identify a plurality of items for performing the one or more services;
for each of the plurality of items, querying an item listings data store of the listing platform to identify one or more item listings for each item;
providing a user interface presenting an indication of the plurality of items and the one or more item listings for each item;
receiving, via the user interface, input indicative of a selected item listing for each item;
generating at least one service order for the one or more services by the service provider and item orders for the selected item listings; and
mapping the item orders to the at least one service order.

2. The one or more computer storage media of claim 1, wherein receiving the input indicative of the one or more services and the service provider to provide the one or more services comprises:
receiving a first input selecting a first service;
querying the services data store based on the first service to identify a plurality of service providers for the first service;
providing a second user interface presenting an indication of the plurality of service providers; and
receiving, via the second user interface, a second input selecting the service provider.

3. The one or more computer storage media of claim 2, wherein the first input selects the first service and a second service, and wherein the services data store is queried based on the first service and the second service to identify the plurality of service providers, wherein each service provider offers the first service and the second service.

4. The one or more computer storage media of claim 1, wherein receiving the input indicative of the one or more services and the service provider to provide the one or more services comprises:
receiving a first input selecting the service provider;
querying the services data store based on the service provider to identify a plurality of services offered by the service provider;
providing a second user interface presenting an indication of the plurality of services; and
receiving, via the second user interface, a second input selecting the one or more services.

5. The one or more computer storage media of claim 1, wherein one or more item restrictions are associated with the service provider, and wherein querying the item listings data store to identify the one or more item listings for each item comprises applying the one or more item restrictions.

6. The one or more computer storage media of claim 1, wherein querying the item listings data store to identify one or more item listings for a first item from the plurality of items comprises:
accessing item data for the first item; and
generating a query using the item data.

7. The one or more computer storage media of claim 6, wherein the first item is a part that needs to be compatible with a primary item, and the query comprises compatibility data based on the primary item.

8. The one or more computer storage media of claim 1, wherein the selected item listings are offered by a plurality of different providers.

9. The one or more computer storage media of claim 8, wherein mapping the item orders to the at least one service order comprises providing an address of the service provider as a shipping address for each item order.

10. The one or more computer storage media of claim 1, wherein the one or more services comprise a primary service having a plurality of secondary services;
wherein the method further comprises receiving a selection of one or more of the secondary services; and
wherein querying the services data store of the listing platform based on the one or more services to identify the plurality of items for performing the one or more services comprises querying the services data store based on the selected one or more secondary services to identify the plurality of items.

11. A computer-implemented method comprising:
in response to input indicative of a selection of a plurality of services, querying a services data store of a listing platform to identify a plurality of service providers that can each provide the plurality of services;
providing a user interface presenting an indication of the plurality of service providers;
receiving a selection of a first service provider from the plurality of service providers;
querying the services data store to identify a plurality of items for the plurality of services;
querying an item listings data store of the listing platform to identify a plurality of item listings for each of the plurality of items;
providing a user interface presenting an indication of each item from the plurality of items and an indication of the plurality of item listings for each of the plurality of items;
receiving input indicative of a selection of an item listing for each of the plurality of items;
generating at least one service order for the plurality of services;
generating an item order for each of the plurality of items; and
mapping each item order to the at least one service order.

12. The computer-implemented method of claim 11, wherein the method further comprises:
in response to receiving a keyword search, querying the services data store to identify the plurality of services; and
providing a user interface presenting the plurality of services.

13. The computer-implemented method of claim 11, wherein querying the services data store to identify the plurality of service providers that can each provide the plurality of services comprises employing a geolocation of each of the service providers to identify the plurality of service providers.

14. The computer-implemented method of claim 11, wherein the plurality of services are selected by:
receiving a selection of a primary service; and
querying the services data store to identify a plurality of secondary services for the primary service, and wherein the plurality of services comprises at least a portion of the plurality of secondary services.

15. The computer-implemented method of claim 11, wherein the item orders are associated with a plurality of different providers, and wherein mapping each item order to the at least one service order comprises providing an address of the service provider as a shipping address for each item order.

16. The computer-implemented method of claim 11, wherein querying the item listings data store to identify a plurality of item listings for a first item from the plurality of items comprises:
accessing item data for the first item; and
generating a query using the item data.

17. A computer system comprising:
one or more processors; and
one or more computer storage media storing computer-useable instructions that, when used by the one or more processors, causes the computer system to perform operations comprising:
in response to receiving input indicative of a selection of a service provider, querying a services data store of a listing platform to identify a plurality of services offered by the service provider;
providing a user interface presenting an indication of the plurality of services;
receiving input indicative of a selection of one or more services from the plurality of services;
querying the services data store to identify a plurality of items for the one or more services;
querying an item data store of the listing platform to identifying a plurality of item listings for each of the plurality of items;
providing a user interface presenting an indication of the plurality of items and the plurality of item listings for each of the plurality of items;
receiving input indicative of a selection of an item listing for each of the plurality of items;
generating at least one service order for the one or more services;
generating an item order for the item listing for each of the plurality of items; and
mapping each item order to the at least one service order.

18. The computer system of claim 17, wherein the operations further comprise:
in response to receiving a keyword search, querying the services data store to identify a plurality of service providers; and
providing a user interface presenting the plurality of service providers.

19. The computer system of claim 18, wherein querying the services data store to identify the plurality of service providers comprises employing a geolocation of each of the service providers to identify the plurality of service providers.

20. The computer system of claim 17, wherein one or more item restrictions are associated with the service provider, and wherein querying the item listings data store to identify the plurality of item listings for each item comprises applying the one or more item restrictions.
